(19) United States
(12) Patent Application Publication
(10) Pub. No.: US 2010/0088187 A1
(43) Pub. Date: Apr. 8, 2010

(54) SYSTEM AND METHOD FOR LOCALIZED AND/OR TOPIC-DRIVEN CONTENT DISTRIBUTION FOR MOBILE DEVICES

(76) Inventors: Chris Courtney, Chicago, IL (US); Jonathan Ozeran, Chicago, IL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/566,646

(22) Filed: Sep. 24, 2009

Related U.S. Application Data
(60) Provisional application No. 61/099,591, filed on Sep. 24, 2008.

(51) Int. Cl. G06Q 30/00; G06F 15/16; H04L 9/32; G06F 17/30

(52) U.S. Cl. 705/14.73; 709/206; 726/6; 707/785; 707/E17.044

(57) ABSTRACT

A computer-implemented method for delivering targeted advertising in an asynchronous messaging-based social networking platform, the system comprising: providing a messaging server configured to managed asynchronous message delivery to a plurality of users, wherein a message comprises: a content title; a timestamp; a profile id, wherein the profile id is a unique identifier associated with a publisher of the message; and a message; providing a user authentication database configured to store and manage user authentication information for the plurality of users; maintaining a plurality of bindings configured to associate at least one user of the system with at least one other user of the system; storing an articles database configured to store messages within the system; identifying a plurality of publishers wherein each publisher posts a plurality of messages within the system; determining a plurality of channels; for each channel, associating a plurality of the publishers with the channel; and providing advertising within the system.

### RELATED APPLICATION

This application claims priority from co-pending U.S. provisional application Ser. No. 61/099,591 filed on Sep. 24, 2008.

### BACKGROUND OF THE INVENTION

1. Field of the Invention

This invention relates to structured localized content distribution for mobile devices and more particularly to a system that extends and capitalizes on microblogging with a local and/or hyperlocal focus.

2. Description of the Background Art

Presently, social networking systems are typically peer-to-peer systems wherein individual users connect with and follow other users within a personal network. This personal network is a subset of the entire network of all users of the respective system, and typically encompasses individuals that are known or are somehow connected to the particular user. Popular modern examples of such systems include FACEBOOK, TWITTER and MYSPACE. These existing systems allow their users to connect with individuals they know or through others they know.

These systems typically allow users to expand the network of people they know through the network of people they already know. A typical approach for a new user to build her network is to create an account or profile, and then reach out to the people with whom she knows to connect. Then, in turn, people that the user knows through others, or with whom she has not spoken or communicated in a long time, will connect with the original user. This has become a popular way for people to reconnect with others they knew long ago. These systems capitalize on the notion of “six degrees of separation,” which is the idea that every person is connected to every other person through a certain number of people in between. These systems do not, however, focus on the information or content that is shared between people and the fact that people who are not connected may very well be interested in the same type of information of content.

FACEBOOK allows its users to grow their network of contacts and “friends” through the people they know. A typical user creates her account on FACEBOOK, and then slowly reaches out to those people she knew previously. As she “friends” more users within the system, the user builds her online network of individuals with whom she interacts.

TWITTER follows a similar scheme. As with FACEBOOK, the users build their own accounts, and then slowly reach out to those they currently know, or those who post information that the user finds interesting or useful. Again, users expand their networks by focusing on people, not information or content.

Some of the difficulties that arise with these approaches concern how to monetize the growth or expansion based on person-to-person interconnecting. Particularly, historical publishing models revolve around a centralized publisher (a newspaper, magazine, or television network, for instance), gathering content of interest to its user base (news stories, television shows, movies, etc.) and selling advertising space within these content streams to industry.

While new social media has expanded exponentially recently, what is lacking is a way for publishers, content distributors, network hosts and the like to combine these new platforms with their existing (and developing) advertising sales channels.

Different systems also allow their respective users to share different amounts and types of information. For instance, one system may allow users to write messages to be shared with their network, while another may allow the sharing of enhanced content, such as videos or images.

Media organizations also participate in these social networks so that their content can be delivered to as many subscribers as possible. But given the current method of internetworking between users of these existing systems, media organizations and others must create profiles or user accounts within these different social networks, and then attract users to join that particular media organization's network within the system, so that the media organization's content can be shared with those users who choose to network with the media organization.

Essentially, media organization must try to “personify” themselves on such social networks in order to participate in the person-to-person internetworking that occurs on such systems and thereby expose the media organization's content to individual users.

These systems also focus on global interaction and networking between users, and thus do not focus on information on a local level.

U.S. Pub. No. 2003/0018521 entitled “Advertising Based Upon Events Reported From A GPS Enabled Event Report System” discloses a system to incentivize event reporters to publish information about particular events to be received by others who are within a certain physical location of the event reporter. This publication fails to disclose sharing this information with others who have previously indicated such information would be important to them.

U.S. Pub. No. 2007/0255807 entitled “Social Networking for Mobile Devices” discloses expanding existing social networking systems to mobile communication devices.

U.S. Pub. No. 2008/0040437 entitled “Mobile Social Networking Platform” discloses interconnecting mobile communication devices with instant messaging applications.

U.S. Pub. No. 2007/0268864 entitled “Method and System to Enhance Social Networking Through Random Location Connectivity” discloses a method and system for randomly connecting people based upon where they are physically located.

The disclosure of each of the above-listed publications is hereby incorporated by reference herein. It should be appreciated that none of the above referenced background art systems teach localized and/or topic-driven content distribution within a social networking system for mobile devices whereby users identify categories of information they are interested in and then receive information posted by other users relevant to these categories.

Therefore, it is an object of this invention to provide an improvement which overcomes the aforementioned inadequacies of the prior art and provides an improvement which is a significant contribution to the advancement of the social networking and media art.

Another object of this invention is to provide a system and method for localized and/or topic-driven content distribution for mobile devices which includes individual users microblogging content which is pertinent to them, wherein the content is then distributed throughout the system to users known and unknown to the microblogging user whereby these users receive this microblogging content because they have previously expressed an interest in a topic or category to which the microblogging content pertains.

Another object of this invention is to provide a system and method for localized and/or topic-driven content distribution in which microblogging content is analyzed to determine an appropriate category of content so that the content is distributed to users who have expressed an interest in receiving such content.

Another object of this invention is to provide a system and method for localized and/or topic-driven content distribution in which advertisers are able to target their advertising on the local, hyperlocal, and/or topic level such that the respective advertising is delivered to users who have self-selected as being interested in content which relates to the advertising being delivered.

Another object of this invention is to provide a system and method for localized and/or topic-driven content distribution in which users that have self-selected as being interested in content which relates to advertising being delivered to them can then save such advertising that they receive on their mobile device through the system for later review or redemption or receive reminders about such advertising, thereby improving the effectiveness of certain advertising, for example, coupons.

Another object of this invention is to provide a system and method for localized and/or topic-driven content distribution where content is classified by channel, subject matter, geographic region, affiliation, or theme.

Yet another object of this invention is to provide a system and method for incorporating relevant advertising into a localized and/or topic-driven content distribution system where the content is classified by channel, subject matter, geographic region, affiliation or theme.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a system and method for localized and/or topic-driven content distribution for mobile devices which includes individual users microblogging content which is pertinent to them, wherein the content is then distributed throughout the system to users known and unknown to the microblogging user whereby these users receive this microblogging content because they have previously expressed an interest in a topic, category, or channel to which the microblogging content pertains. The system may comprise analyzing the content to determine an appropriate category of content so that the content is distributed to users who have expressed an interest in receiving such content. Advertisers could thus use the system to purchase advertising at the local, hyperlocal, and/or topic level which is particularly important to the respective recipient of the advertising.

The system additionally comprises a microblogging platform including structure, such as channels divided by theme, subject-matter, geographic region, affiliation or the like.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other systems and methods for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 diagramatically depicts a social networking system.

FIG. 2 is a flow chart of a localized content distribution system.

FIG. 3 diagramatically depicts an ayschronous messaging system.

FIG. 4 diagramatically depicts a user interface for the asynchronous messaging system.

FIG. 5 is a flow chart showing the flow of a user-interaction with the system.

FIG. 6 is a flow chart showing the flow of a network or channel operator's interaction with the system.

Similar reference characters refer to similar parts throughout the several views of the drawings.

### DETAILED DESCRIPTION OF THE PREFERRED EMBODIMENT

The following terminology is understood by those skilled in the art, but the following description of these terms will be helpful in explaining this application. “Microblogging” is generally understood to comprise short messaging exchanged among a group of participants. This messaging can be delivered in any number of underlying formats and protocols, including Short Message Service (SMS), Instant Message (IM), Internet Relay Chat (IRC), or any other messaging or communication protocol.

“Social networking” is currently generally understood to be the networked or online interaction between various users. Such social networking can be built on any of a number of underlying networks, including the Internet, Local Area Networks (LAN), Wide Area Networks (WAN), and the like.

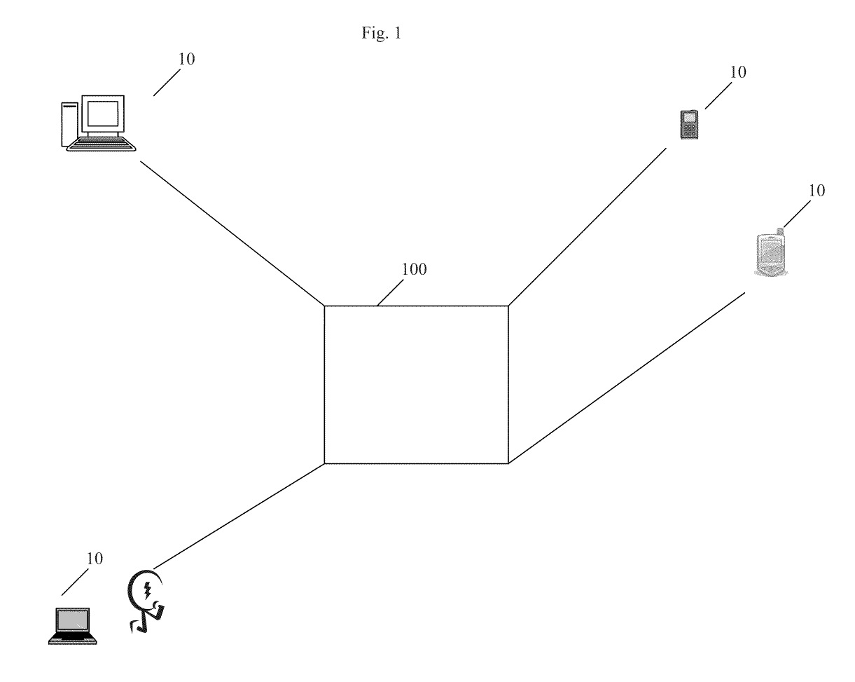

Turning to FIG. 1, a content-distribution system is depicted. The system includes infrastructure for managing the system, including computer and networking equipment. Users 10 of the system participate through any number of means, including computers (which comprise a CPU, memory, and input components), personal digital assistants, telephones, or any other similar communications device. These devices can be networked devices, both wired and wireless. Communication can be had over any network, using various communications protocols.

The system is configured to allow both free-form interaction and structured interaction. The free-form interaction provides social networking capabilities where users receive messages posted by other users and where such users are able to post their own messages. The system can be configured in a number of ways. In one embodiment, all messages input by all users are delivered to all other users of the systems. In another embodiment, users only receive messages from those publishers whom the user has pre-selected as someone the user is interested in receiving messages from. For clarity, the term “publishers” in the preceding sentence is to be understood as any user of the system who posts any content. This could include individual users posting information to be shared among friends, industry users posting advertising or promotions or other similar content to be sent to potential and existing customers, or media organizations posting content to be exposed to users.

In a preferred embodiment, the infrastructure components of the system include a database or other data management system. Because the system comprises users posting content which is analyzed for relevance and topic (as explained below), the data management system needs to receive this content from the relevant publisher of the content, process the information, and then redirect it accordingly. A preferred data management system is a relational database management system, such as PostgreSQL, Oracle, SQLServer, or other similar system.

Users

“Users” come in many different forms within the system. “Users” can be defined to have one of the following roles: a platform user; a system administrator; a network and/or channel operator; a system process; an advertiser; or an external user.

A platform user is a user who interacts with the system directly through the system's platform. Such a user could interact with the system through a computer, personal digital assistant, smart telephone, or any other communications device.

A system administrator is a user who is charged with administering the system. This user typically would have additional privileges and permissions over other users facilitating control of the system or certain aspects of the system.

A network and/or channel operator is a user who is charged with operating a network or channel within the system.

An advertiser is a user who provides advertising or promotions within the system.

An external user is one who interacts with the system through an externally facing Application Programming Interface (API), or other developer platform. For instance, an external user could be one that interacts with the system through an embedded widget built by a third-party provider, a third-party application running on a third-party piece of equipment, such as an iPhone from Apple®, a television ticker tape widget, or any other application.

Each user within the system is assigned a unique identifier, also called a “profile id.”

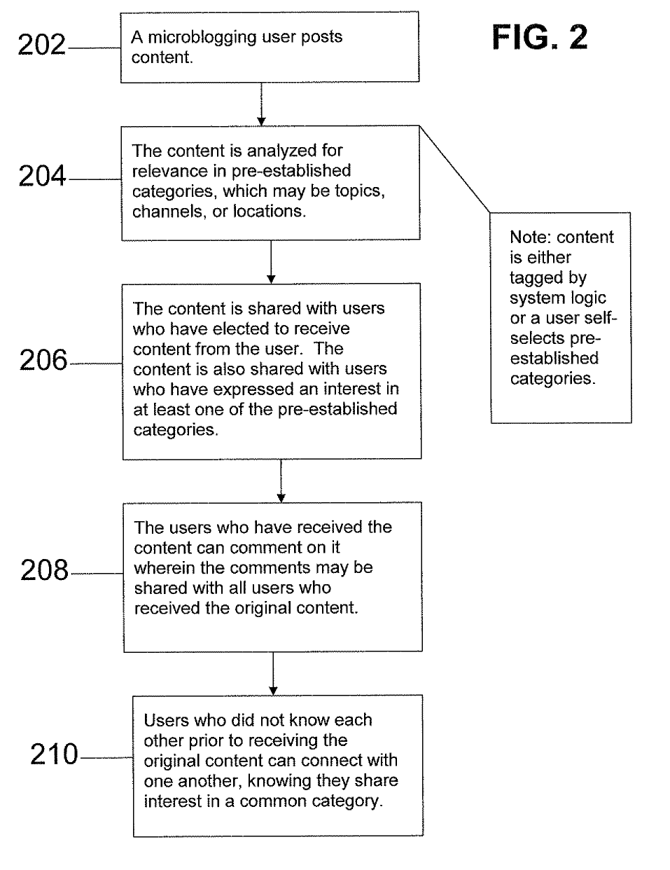

FIG. 2 is a flow chart depicting a localized content distribution system described herein. At step 204, the content is analyzed to determine pre-existing categories to which the content is relevant. Any number of methods can be used to determine the relationship of the content to the categories. For instance, in one embodiment, the system can search through the content for various keywords. The system can be configured to have certain categories of interest. When messages are received by the system, the messages can be analyzed to determine relevance as they relate to the categories. Where there is a match (or certain degree of relevance), those messages can be placed on the feeds which relate to those categories. A single piece of content can be relevant to one or more than one category. Thus, at step 206, the content is shared with users 10 who have identified an interest in receiving content pertaining to the relevant category.

Users 10 can select which categories of content that interests them in a number of ways. In one embodiment, users explicitly select pre-existing categories which are of interest to them. In another embodiment, the system 100 analyzes the user's 10 activities to determine categories that would be appropriate for such a user, which could be accomplished either through automatic system logic or through active moderation. For instance, if user 10 regularly posted content about the Chicago Cubs, the system 100 might assign a category relating to the Cubs to the user 10. Of course, the system 100 would not force this selection upon the user 10 and various methods could be implemented to allow the user 10 to configure which categories are of interest (for example, recommended categories, “Did you mean?” queries, etc.).

At step 208, the content has now been delivered to the users 10 who were interested in the particular category to which the content is relevant. These users who have received the content can now respond and provide their own content. In a preferred embodiment, such content would include comments relating to the original comment. As users 10 can now see comments and other content from other users 10 who are interested in the same category of information, those users 10 can connect with one another to expand their own networks, as shown at step 210.

Using the present invention, media entities and other persons who are interested in disseminating information to a large number of people can participate in such a social networking system 100 and provide relevant content. For instance, the Chicago Cubs could advertise certain advertisements or promotions to those users who are interested in the Cubs. The Cubs could accomplish this by purchasing an advertising campaign through the system's self-service advertising platform interface that contains one or more categories relevant to a particular Cubs promotion or advertisement. Those users 10 of the system who have self-selected as being interested in the categories purchased as part of the Cubs advertising campaign would receive the advertisement or promotion provided by the Cubs. One of the many inventive features is that the users do not need to first indicate that they want to receive content or information from the Cubs. Instead, users indicate they want to receive content or information about the categories which the Cubs have selected as part of their advertising campaign. Thus, when anyone (including an advertiser) disseminates information about a particular category, interested users will receive that information without needing to first be connected with the entity posting the information. As would be evident to one skilled in the art, systems would be in place to prevent abuses of these inventive features to avoid situations where individuals, such as spammers, attempt to post irrelevant information. Importantly, users 10 of the system could then save any promotions or advertisements received from the Cubs that they receive on their mobile device for later review or redemption or receive reminders about such promotions or advertising and intervals a user could select. Users 10 of the system can therefore digest advertisements or promotions at a time that is convenient for them. Additionally, advertising effectiveness is improved because users 10 have effectively stored the promotion or advertisement for later use or redemption through their mobile device—in effect, taking the promotion or advertisement and “putting it in the pocket” of the user.

The present invention empowers users 10 to follow what they are interested in, rather than just following what their network of contacts and other users are interested in at the time. Additionally, users 10 do not have to opt-in to particular content feeds, such as by subscribing to a Really Simple Syndication (or other RSS) feed, or any other periodically updated content. Rather, users 10 of the present system 100 identify the type of information in which they are interested. This enables users 10 of the present system 100 to connect not only with other users 10 they know, but also with other users 10 they do not know but who share a common interest.

The system 100 also capitalizes on the mobile nature of the users 10. In a preferred embodiment, users 10 connect to the system through mobile communication devices, such as a mobile telephone. In one embodiment, the mobile telephones used by the users can contain GPS or any other location detecting apparatus so that the user's 10 position can be utilized within the system 100. Preferably, the mobile device is a 3G or higher-speed GPS enabled mobile device. Thus, if a user 10 detected a traffic accident on her way home, she could post an entry which identifies the accident. The system 100 would then send that information not only to the users 10 who are connected to the posting user 10, but also to other users known to be near or in the vicinity of the accident. Additionally, the system 100 could also send the information to others that are not nearby, but who are known to have some reason to come to that area. For example, the system 100 could also send the message to a user 10 who is known to live nearby. In the same ways, advertisers could send advertisements or promotions to users 10 that have self-selected as interested in the categories that are part of an advertiser's campaign that may also be in the vicinity of the advertiser, for example a retail establishment that is near the location of the user at a given time.

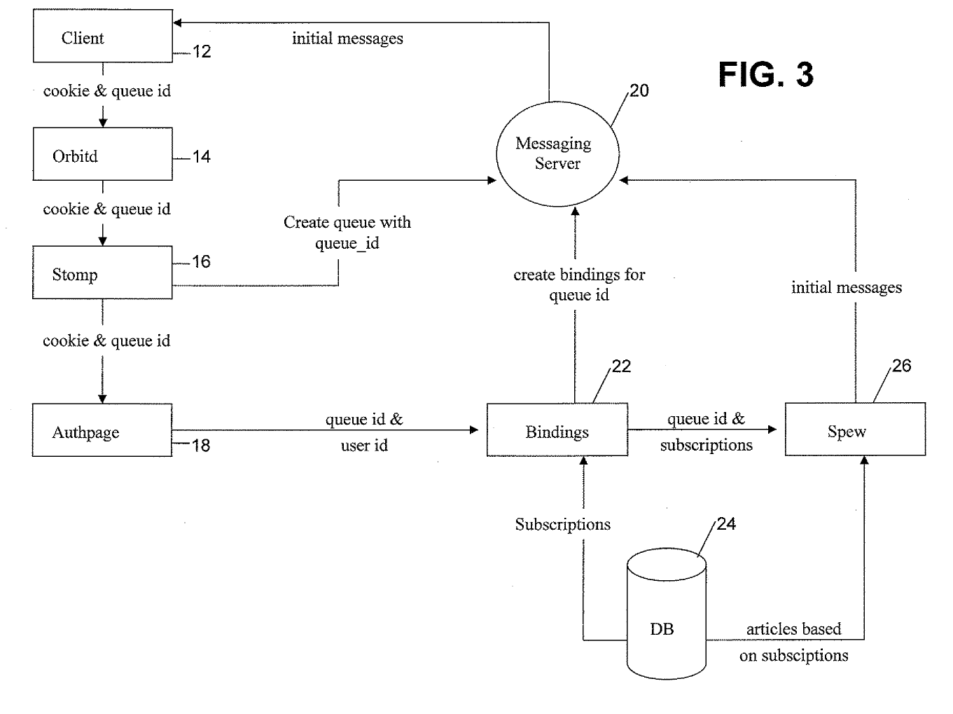

As shown in FIG. 3, the system 100 comprises a messaging server 20, bindings 22, and a database 24. Users 10 interact with the system via various clients 12. A user is authenticated as shown via an authentication mechanism 18. This authentication mechanism can use a username/password combination, or any other authentication option. Once authenticated, a user is provided credentials indicating such authentication. In the web environment, these credentials can be in the form of a cookie provided to the user's web browser. With each further request from the user, the cookie is provided to the system. These credentials passed to the system will identify the user, including providing the user's unique id, discussed below.

As discussed below, the system manages bindings 22 for each user, mapping the user's profile id to the user's queue (not depicted). The discussion below provides further details on the bindings and user queues. The system also includes a database 24 for storing historical messages, as well as other information. User information, including demographic information, can be stored in the database 24, or any other data store.

In a preferred embodiment, the system is built upon an asynchronous messaging server 20. A preferred embodiment utilizes the Advanced Message Queuing Protocol (AMQP) as the application layer protocol specification for asynchronous messaging. The AMQP specification, which can be found at http://www.amqp.org, is herein incorporated by reference.

A preferred embodiment utilizes the RabbitMQ Enterprise Message system, which is built upon AMQP. Details on RabbitMQ can be found at http://www.rabbitmq.com/ and are herein incorporated by reference.

In a preferred embodiment, a virtual machine/server runs the RabbitMQ server instance. As would be appreciated, this could be multiple clustered virtual machines running multiple server instances. For the sake of simplicity, the following disclosure may be in terms of a singular machine, but it should be understood that this also includes the implementation where farms or clusters of machines are utilized to provide additional computing power and resources.

The server instance simultaneously connects to a data storage system. Preferably, the data storage system is a replicated database cluster. This data storage system is used for storage of processed messages and resources. Both the messaging server (e.g. RabbitMQ) combined with the data storage system are further integrated with load-balancing systems. These load-balancing systems handle the network traffic and data requests and ensure that such requests are balanced among the appropriate equipment. A preferred embodiment uses Ruby on Rails for load-balancing.

The Messaging Format

The messaging format or protocol used herein is important for a proper understanding. A message herein comprises: a content title, a publish date/timestamp, an owner profile id, and content. The message can additionally comprise a geolocation wherein geolocation is understood to mean geographic information. The message can additionally comprise related resources. Resources herein can be any additional information, such as a Uniform Resource Locator (URL), an image file, a video file, an audio file, or any other data file. Of course, any other resource could be included herein as well. A message within the system is also sometimes called an article. In a preferred embodiment, the message content is 140 bytes or less so that the system can work with a Short Message Service (SMS) communication platform.

A message can also include zero or more “tags.” One way of implementing such a feature is by prefixing the tag with a certain delimiter, such as the hash character (#), within a message. For instance, the following message: “I like the Chicago #Cubs,” has the tag “Cubs.” When such a message is received by the messaging server, each tag within the submitted message is added as a tag attribute to the given message. In the case where content from trusted and approved external sources is directly imported via system processes, these message are also transmitted initially into the messaging server where, again, an optional tag attribute can be populated from the ingested content. For those messages that are stored in the database (discussed below), any tags associated with those messages can also be stored in the database.

In a preferred embodiment, the messaging server 20 utilizes the Streaming Text Orientated Messaging Protocol (STOMP), the full specification of which is herein incorporated by reference. STOMP is a simple text protocol which provides an interoperable wire format for allowing STOMP clients to communicate with STOMP message brokers. The protocol includes the following commands: SEND, SUBSCRIBE, UNSUBSCRIBE, BEGIN, COMMIT, ABORT, ACK, DISCONNECT.

The messaging server 20 herein makes messages accessible by way of a communications protocol. In a preferred embodiment, that communications protocol is STOMP. The primary web interface (discussed in more detail below), is built as an asynchronous AMQP client, which connects to the messaging server 20 via the STOMP protocol. This web interface forms and maintains connections to the messaging server 20. Other AMQP clients are also used to make connections to the messaging server 20. For instance, these clients can include smart phones, such as a Blackberry, iPhone, Palm Pre, Android device, or any other similar communications device.

Bindings

Valid profile ids determine how a user of the system will receive an asynchronous real-time feed of messages from the system. As mentioned above, every message in the system comprises a profile id. This profile id serves to identify who the publisher of the particular message is. When a user opts to subscribe to another user's feed, a binding is made between the requesting profile id and the source profile id. Using these bindings, first-in first-out (FIFO) queues are created and managed to handle the retrieval and subsequent addition of new feed messages as they are generated, processed and/or made available throughout the system.

For added clarity, each user within the system is assigned a unique queue id. This queue id links to a unique queue for handling messages to be delivered to that particular user. The queue is a first-in first-out data structure, meaning that the first message entering the queue will be the first message delivered to the user (and thus leaving the queue). When user A subscribes to user B's feed, user B's messages (also called posts) are copied into user A's queue (and any other user who has subscribed to user B's feed). Thus, user A will be presented with user B's feed.

Messaging Protocol

The following discussion describes a messaging protocol utilized in a preferred embodiment. As one of skill in the art would appreciate, however, any messaging protocol, particularly an asynchronous messaging protocol, could be used.

AMQP is an application layer protocol specification for asynchronous messaging. The AMQP model unifies messaging patterns (such as the publish/subscribe, queues, transactions and streaming) while adding extra capabilities such as easily extensible, content-based routing. Publish/subscribe in this context means the decoupling of producers and consumers. Producers do not need to know which criteria consumers use to receive a message. Rather, routing decisions control which messages will eventually be placed in the message queues present in an asynchronous messaging system.

In a preferred embodiment, a database management system is used for storage and retrieval of messages which have previously been presented within the system. These previously presented messages can be thought of as messages that were previously delivered in “real-time.” The database management system stores these messages so that users who access the system after these messages have been sent can still be presented with these messages. Preferably, the database management system is a PostgreSQL database cluster, or any other similar database management system.

As mentioned before, each message includes a profile id. A database is also utilized for storing each of the profile ids assigned in the system, as well as other information which corresponds to that particular user. This other information can include demographic information about the user, such as age, gender, address, location, interests, or other similar information. This is particularly important as this type of information is highly relevant to advertising and marketing efforts. By maintaining this other information corresponding to a particular user, and associating it with each message within the system, appropriate advertising, promotion and marketing materials can be provided directly to the users who are most likely to benefit from that information. For example, a user who lives in Chicago, and subscribes to topics, categories, or channels concerning the Chicago Cubs, would be a prime target for advertising related to the Chicago Cubs.

Returning to the messaging protocol, when a user posts a message into the system, the messaging server allows that message to be bound to a queue (or multiple queues) where other users and/or entities have subscribed to that profile id. This underlying feature allows the system to serve new messages, responses to existing messages, system-ingested content from external sources, advertising and promotions (including “in-feed deals” and “takeovers,” which will be discussed in further detail below), as well as any related resources (including links, URLs, thumbnails, static coupon images (discussed in further detail below), dynamically generated barcode, dynamically generated two-dimensional bar code (also called a QR, or QR code), or any other resource).

Search

The system also supports capabilities for searching the messages, responses to messages, system-ingested content from external sources, advertising and promotions, as well as any resources therein. This is useful and helpful when a user joins the system, or decides she has a need to look for messages pertaining to a certain subject or topic. By finding other users who post information relating to a particular topic, the user will not only be able to gather information pertaining to her search query, but will also be able to grow her network of contacts from whom she receives messages, should she decide to subscribe to any users she discovers during the search.

Article Database

The messaging server is not responsible for storage of any messages transmitted through its architecture. Rather, it is responsible for delivering messages in real-time to subscribers via a set of bindings that are handled via a queuing system, discussed above. Once messages have been received, the replicated database cluster stores and archives content for indexing, search, analytics, and trending purposes. The system collects and manages the granularity and organization of messages and related resources through the unique nature of the networks and channels. Given that the user profiles and bindings correspond to profile ids, the system herein allows an advertiser the ability to easily serve an advertisement or promotion to a highly targeted and specific set of users by allowing them to specify to whom their advertisement or promotion should reach. That advertisement or promotion can then be added to the matching user's bindings. Further, the system can control the frequency at which that advertising or promotion gets delivered to a user's queue, irrespective of how that user is accessing the system.

Furthermore, the system can utilize geolocation information to tailor appropriate advertisements or promotions to deliver to a user in a particular location. For instance, a retailer could run an advertisement or promotion which sends a coupon to all users who are located within a 5 mile radius of the retail establishment. Of course, any other radius length could be used.

Additionally, the system could utilize the user's respective registration and demographic information to tailor the advertising delivered.

Advertising Advantages

The term “advertising,” as used throughout this entire document is to mean advertisements or promotions. Given the structure provided to the system, particularly the use of localized topics, categories or channels, advertising and promotions can be presented in a highly personalized and relevant manner. In this discussion, advertising takes two primary forms: “in-feed deals”; and “takeovers.”

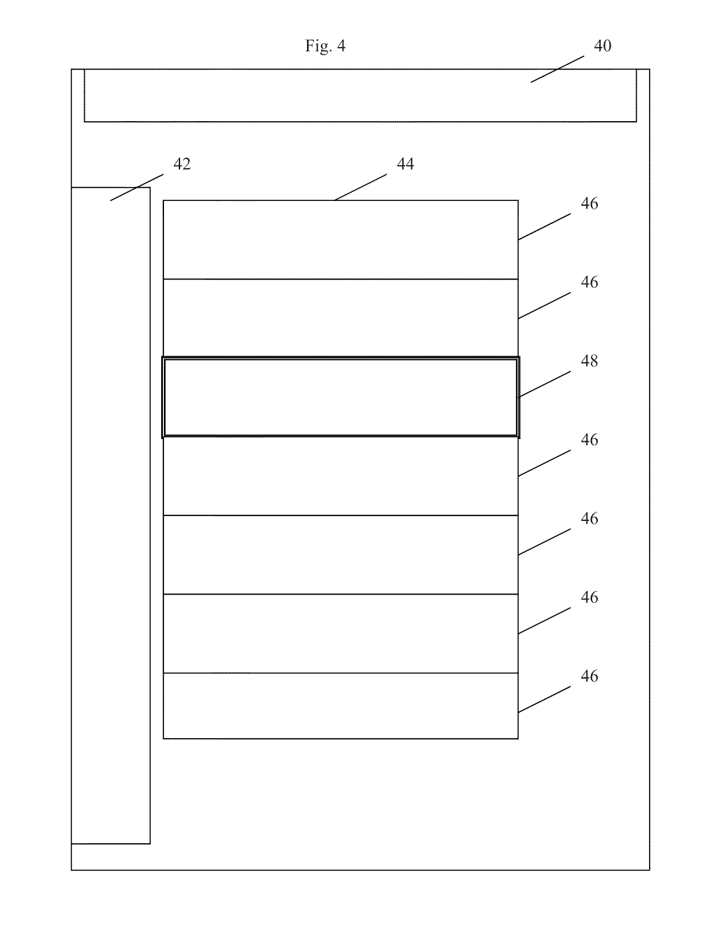

As its name suggests, “in-feed deals” are advertisements or promotions presented within a feed. An example is shown in FIG. 4, wherein an interface that a user could be presented with is depicted. The user could access this interface through any number of means. For instance, the user could use a web client, such as Mozilla's Firefox, Google's Chrome, Microsoft's Internet Explorer, Apple's Safari, Opera Software's Opera, or any other web browser. Alternatively, the user could use a smart telephone, such as a Blackberry, an iPhone, a Palm Pre, an Android device, or any similar device.

Returning to FIG. 4, the interface has a masthead advertising area 40, side banner advertising area 42, and a messaging area 44. Of course, FIG. 4 is exemplary and any combination is possible, for instance including a plurality of side banner advertising areas 42, masthead advertising areas 40 and the like. Within the messaging area 42, a graphical presentation of the user's messaging queue is presented, showing the messages 46 contained therein. An “in-feed deal” is shown at 48. This type of advertising shows up as another message within the user's queue. Numerous options can be sold to the advertiser and incorporated into the “in-feed deal” including: color, size, shape, highlighting, font, font size, pictures, video, audio, or any other media to be included therein. As depicted, the “in-feed deal” is being highlighted by way of a stronger border around the message. Any other method used to draw attention to the advertisement or promotion could be included, and then sold to the advertiser as a way of incorporating the advertiser's promotion.

“Takeovers” take advantage of a similar interface presentation to the user. Instead of dealing with the messaging area 44, “takeovers” alter the content displayed in the masthead area 40 and side banner advertising areas 42. As above, various customizations can be offered, including color management, image inventory (including which images to display in which portions and for what duration of time), time of the promotion, duration of the promotion, etc. Both “takeovers” and “in-feed deals” can be displayed to the users based upon certain time or duration measurements. In one example, time could be measured by clock time, whereby an advertisement or promotion is presented for a period of seconds, minutes, hours, days, or the like. Alternatively, time could be measured by message time, whereby an advertisement or promotion is presented for as long as it takes for that particular user to receive a certain number of messages. Similarly, advertisements or promotions could be configured to only be shown during certain times of the day depending on the location of the user who is seeing them. For instance, a user on the east coast at 8:00 p.m. might receive advertising related to primetime entertainment, while a user on the west coast, where it is 5:00 p.m., might receive advertising related to the afternoon commute.

Additionally, as described above, geolocation information can be stored and managed relating to the particular user. This information can be utilized with and combined with the advertising, so as to enable advertisements or promotions to be presented to those users within a certain radius or distance from a location. In a preferred embodiment, this can be implemented by specifying the location of the advertisement or promotion and a radius to which that advertisement or promotion extends, and then for each user whose queue is to receive that advertisement or promotion, comparing the advertisement or promotion's specified location with the user's geolocation information and seeing if the latter falls within a certain radius or distance of the former. If so, the advertisement or promotion is presented to the user by being placed in that user's queue. Alternatively, if not, the advertisement or promotion is not presented to that user (or some other alternative advertising is).

The interface could also include controls allowing the user to post her own content in her own feed. These controls would include areas for entry of the message and any additional resources the user would want attached thereto. The interface also includes controls allowing the user to post her message. Upon posting the message, the system appends the other necessary message information including the user's unique id, and a date/timestamp. Furthermore, if the user's client has the capability, and the user has permitted, the user's geolocation information can be included in the message. Alternatively, if the user's client does not automatically provide the geolocation information, other alternatives can be implemented, including allowing the user to provide this information, or attempting to gather this information based on other factors, such as by triangulating a cellular signal, reverse analyzing a particular internet protocol address (and then mapping that to a geographic area) or any other alternative.

The user-interface could also include controls (not depicted) for selecting topics, channels, or deals. Each of these is discussed below.

By selecting the topics option, the user is presented with an interface (not depicted) wherein feeds are categorized by topic. These topics can be either preconfigured categories or topics, or programmatically determined topics. In one embodiment, any user can post information which can appear in a particular topic's feed. In another embodiment, only publishers who have been preapproved by a certain party (for instance, a content editor or the like) may post to a certain topic. Through this approach, the content editor, be it a system-wide or only topic-wide position, can select which publishers are able to post content related to the particular topic.

The channel page works similarly. As with topics, there are preselected channels. In a preferred embodiment, these channels will pertain to particular areas of interest. For example, there could be a Chicago Cubs channel. As with topics, in a preferred embodiment, a content editor (either system-wide or channel-specific) controls who is permitted to post content on the particular channel. Thus, users looking for information about the Cubs will only get content-editor approved information on the Cubs channel, without needing to wade through the noise that would otherwise be present in such a socialized network system.

A designated area for deals can be used for presenting additional advertising material to the user, as well as providing the user the ability to store advertising for later use. For instance, if the user is presented with a digital coupon (be that a bar code, a coupon, etc.), the user could be presented the option to save that advertising for later use. As an example, if a user walks by a pizza parlor and is presented with a coupon for half off a large pizza pie, but does not want a pizza until later in the day, the user could save that coupon to her designated area for deals, and then retrieve or redeem it later when she visits the pizza parlor.

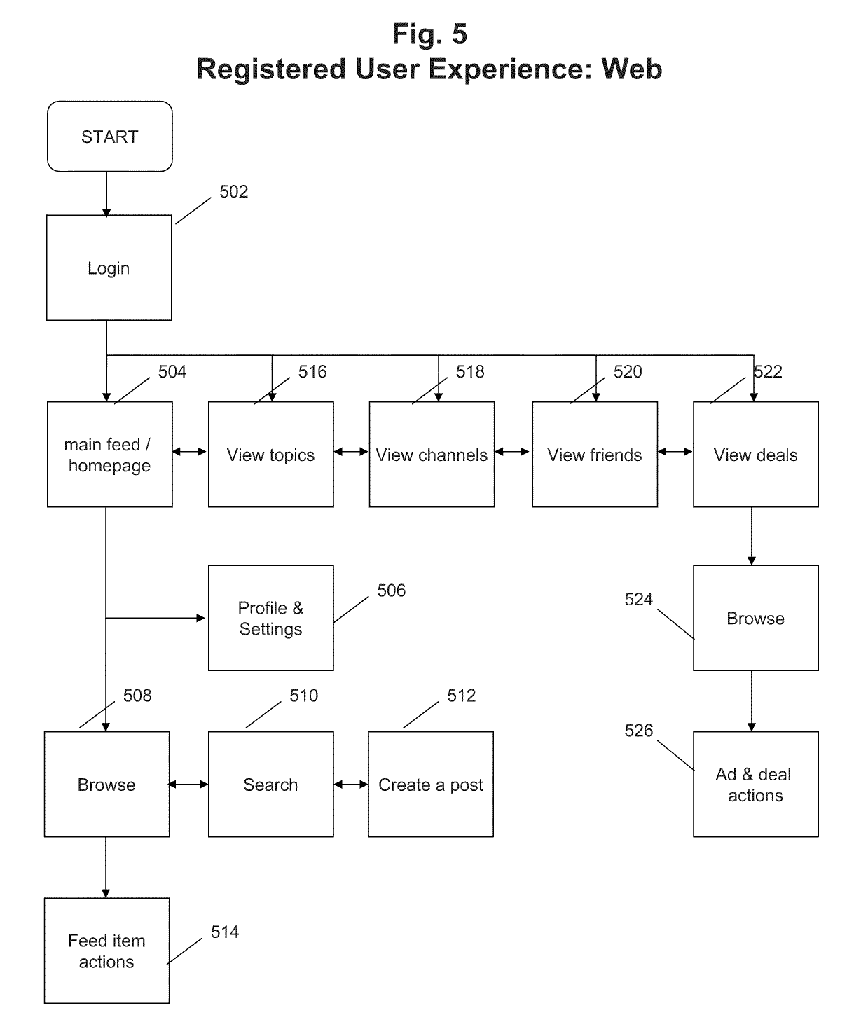

FIG. 5 depicts a preferred user-interface flow for interacting with the present system. When the user logs in, she is presented with the homepage 504. From here, she can select to view topics 516, channels 518, friends 520 or deals 522. Alternatively, she may adjust her profile and settings 506, or browse 508 through the system. Further, for each feed item the user comes across, she can perform additional actions 514, i.e. learning more about the publisher of that particular feed item.

If the user chooses to view topics 516, she will be presented with all posts that match up with her interests. If the user chooses to view channels 518, she will be presented with all channels that she has subscribed to. Selecting view people 520 provides the user with her friends' feeds. And selecting view deals 522 allows the user to navigate her designated area for deals and view not only her saved deals, but also other deals within the system based upon those deals' popularity, location, etc.

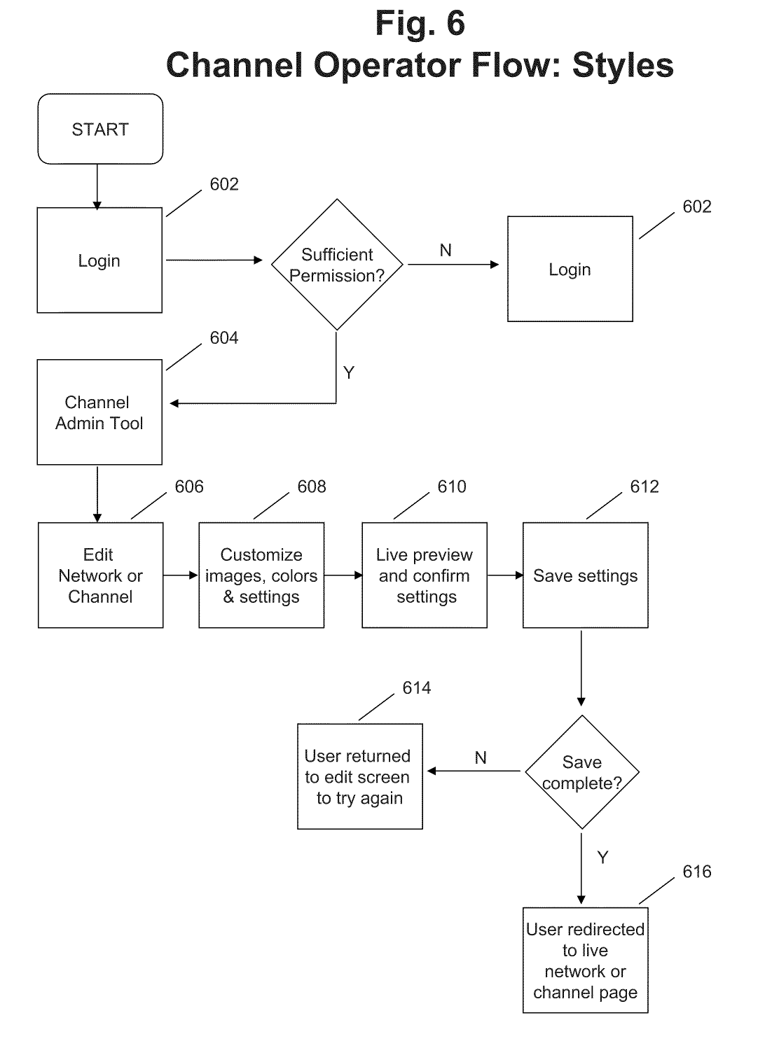

FIG. 6 depicts the interface flow for a network and channel operator. After the network or channel operator logs in 602, she is presented with the administrative tool 604. This tool allows her to edit the channel or network 606, including modifying colors, images and settings 608. Once the modifications are complete, the channel operator can test those settings in a live preview environment 610. This live preview permits the advertiser to view an advertisement or promotion as rendered in the actual environment of the client device, including on a mobile device. Finally, the user can save those settings 612 for the network or channel.

The channel structure and methodology would benefit from added discussion as it provides many of the advantages of the present system. In a preferred embodiment, as discussed above, the channel system is regulated or controlled by the central content operator or controller of the system. For instance, the provider of the content-distribution system of this invention could be the central content operator. Of course, these tasks could be delegated to different organizations, and it is not required that they be performed by one and the same entity.

One of the duties of the central content operator is to control what channels exists, and who is authorized to publish content therein. By adding pre-selection and pre-screening requirements, the content that is distributed on a particular channel is more likely to be relevant to described subject matter, as some content editor has deemed the publisher proper for distributing that type of information. An example would be helpful. Any user of the system could post information about the Chicago Cubs. Ordinary users of the system might post information relating to their personal experiences with the Chicago Cubs (i.e. “I just drove by Wrigley Field.”). That user's friends might be interested in that piece of information. Those users will receive that information by subscribing to the publishing user's feed. Perhaps others might find the sheer mention of Wrigley Field interesting. Those users will receive that information by subscribing to that topic. But those users who simply want information about the Chicago Cubs, without the noise or chatter associated with individual user messages, would not find that message interesting. Similarly, an advertiser looking to sell advertising to Cubs fans will want a broader reach of advertising recipients than those interested in the “noisy” posts.

As mentioned above, a central content operator can control channels. This enables the central content operator to determine trusted publishers as the only entities permitted to distribute messages on the respective channels. For example, a content operator in charge of a Chicago channel could determine the Chicago Tribune is a trusted publisher for that channel. Thus, users have knowledge that the content will have a certain level of relevance (with less noise associated with numerous individual user messages) because the publishers on that channel have been preselected as being qualified to so publish. The system operator could allow other publishers on the respective channels. This way, subscribers to the channels gather relevant and interesting information from numerous trusted sources. without having to weed through the noise created by individual user messages.

Trends

Additional features provided are the ability to follow and measure trends within the system. Trends can include topics that are popular at that instant. One way of determining which topics are currently popular is by investigating those messages currently being distributed within the system. By analyzing those messages, it can be determined, by a count for instance, how many messages pertain to a certain topic, or have a certain tag. Whichever topic or tag has the highest count could then be presented as the most popular current topic or tag, and so forth.

Given the user's geolocation information within the system, trending analysis can also be performed on a more localized level. Using a similar approach, messages within a certain radius can be analyzed for popularity (or other criteria). Thus, if numerous users around a certain point of the highway in a city each post a message asking “Is there traffic jam,” this could be an indication that a traffic incident exists within the region surrounding those users. From an advertising perspective, at a sporting event, concert, or other event where numerous people gather, an advertiser could present an advertisement or promotion to the participants at the particular show, or create promotions and games for those in attendance to play, such as a trivia game asking those in attendance to answer certain questions via the system

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method of structured content distribution comprising:
pre-establishing a plurality of channels on which to distribute information;
for each pre-established channel, determining a plurality of publishers who are permitted to distribute content on the respective channel;
gathering a plurality of user contact information;
for at least one user, storing an association between the user and at least one channel;
receiving a first message from one of the users and distributing the first message to other users in the system who have pre-selected an interest in receiving messages from that user;
receiving a second message from one of the publishers, determining which channels the publisher is publishing on, and distributing the second message to each user who has associated himself with the determined channel;
wherein the first message comprises a title, a profile id, a date stamp, and content;
presenting advertising to the users; and
storing each message in a database for later retrieval.

2. A computer-implemented asynchronous messaging system comprising:
a messaging server configured to manage asynchronous message delivery to a plurality of users, wherein a message comprises:
a content title;
a timestamp;
a profile id, wherein the profile id is a unique identifier associated with a publisher of the message; and
a message;
a user authentication database configured to store and manage user authentication information for the plurality of users;
a plurality of bindings configured to associate at least one user of the system with at least one other user of the system; and
an articles database configured to store messages within the system;

3. The system of claim 2 wherein the message further comprises geolocation information.

4. The system of claim 3 wherein the geolocation information comprises Global Positioning Satellite information.

5. The system of claim 3 wherein the geolocation information comprises a zip code.

6. The system of claim 3 wherein the geolocation information comprises an Internet Protocol address.

7. The system of claim 2 wherein the message further comprises a resource.

8. The system of claim 7 wherein the resource is a Uniform Resource Locator.

9. The system of claim 7 wherein the resource is an image.

10. The system of claim 7 wherein the resource is an audio file.

11. The system of claim 7 wherein the resource is a video file.

12. The system of claim 2 wherein the message further comprises a tag.

13. A computer-implemented method for delivering targeted advertising in an asynchronous messaging-based social networking platform, the system comprising:
providing a messaging server configured to managed asynchronous message delivery to a plurality of users, wherein a message comprises:
a content title;
a timestamp;
a profile id, wherein the profile id is a unique identifier associated with a publisher of the message; and
a message;
providing a user authentication database configured to store and manage user authentication information for the plurality of users;
maintaining a plurality of bindings configured to associate at least one user of the system with at least one other user of the system;
storing an articles database configured to store messages within the system;
identifying a plurality of publishers wherein each publisher posts a plurality of messages within the system;
determining a plurality of channels;
for each channel, associating a plurality of the publishers with the channel; and
providing advertising within the system.

14. The method of claim 13 further comprising:
receiving messages from the publishers and distributing those messages on the associated channels.

15. The method of claim 13 further comprising:
associating a plurality of users with a plurality of the channels.

16. The method of claim 15 further comprising:
receiving messages from the publishers and distributing those messages on the associated channels to the users who are associated therewith.

17. The method of claim 13 wherein the advertising is an in-feed deal, such that an advertisement is presented to a user as though the advertisement is a message in the system.

18. The method of claim 17 where the in-feed deal is a different color from other messages in the system.

19. The method of claim 17 where the in-feed deal is presented to the user for a predetermined period of time.

20. The method of claim 13 where the message further comprises geolocation information.

21. The method of claim 20 wherein the advertisement is determined with regards to the geolocation information.

22. The method of claim 13 where the advertising is a takeover such that an advertisement is presented to the user as though it has taken over the majority of the user interface.
